(19) United States
(12) Patent Application Publication
(10) Pub. No.: US 2026/0022659 A1
(43) Pub. Date: Jan. 22, 2026

(54) INTAKE AIR HEATING SYSTEM, OPERATION METHOD FOR INTAKE AIR HEATING SYSTEM, AND GAS TURBINE SYSTEM

(71) Applicant: MITSUBISHI HEAVY INDUSTRIES, LTD., Tokyo (JP)

(72) Inventors: Masaya KATO, Tokyo (JP); Tomoyuki MATSUI, Tokyo (JP)

(21) Appl. No.: 18/997,999

(22) PCT Filed: Jul. 24, 2023
(86) PCT No.: PCT/JP2023/026917

§ 371 Date: Jan. 23, 2025

(30) Foreign Application Priority Data
Aug. 10, 2022 (JP) 2022-127617

(51) Int. Cl. F02C 7/08; F02C 3/10; F02C 7/057

(52) U.S. Cl. CPC F02C 7/08; F02C 3/10; F02C 7/057

(57) ABSTRACT

This intake air heating system is configured so as to heat external air flowing in an intake air flow path communicated with a compressor of a gas turbine, the intake air heating system comprising: a first heating unit that includes a return flow path for returning some compressed air discharged from the compressor to the intake air flow path; a second heating unit that includes a heater configured so as to utilize a heat source differing from the compressed air to heat the external air; and a control device that is configured so as to control the second heating unit such that the external air is heated by the heater in a high load segment where the gas turbine load is higher than a first stipulated load.

### TECHNICAL FIELD

The present disclosure relates to an intake air heating system, an operation met hod for an intake air heating system, and a gas turbine system.

The present application claims priority based on Japanese Patent Application No. 2022-127617 filed in Japan on Aug. 10, 2022, the contents of which are incorporated herein by reference.

### BACKGROUND ART

In the related art, an intake air heating system that heats external air supplied to a compressor of a gas turbine is known. For example, a heating unit of a gas turbine disclosed in PTL 1 is configured to heat external air by using compressed air as a heat source. The heating unit includes a return line for returning some of the compressed air discharged from the compressor to an intake duct. The external air is heated by mixing the compressed air flowing through the return line with the external air flowing through the intake duct.

### CITATION LIST

### Patent Literature

[PTL 1] Japanese Unexamined Patent Application Publication No. 2000-097046

### SUMMARY OF INVENTION

### Technical Problem

In the gas turbine, when the heating unit executes heating, there is a concern that operation efficiency of the gas turbine may be reduced. This is partly because the flow rate of combustion gas supplied to the turbine is reduced by the amount of some of the compressed air discharged from the compressor, the compressed air being returned to the intake duct.

An object of the present disclosure is to provide an intake air heating system, an operation method for an intake air heating system, and a gas turbine system that improve operation efficiency of a gas turbine.

### Solution to Problem

An intake air heating system according to at least one embodiment of the present disclosure is an intake air heating system configured to heat external air flowing through an intake flow path that communicates with a compressor of a gas turbine, the intake air heating system including:
a first heating unit including a return flow path for returning some of compressed air discharged from the compressor to the intake flow path;
a second heating unit including a heater configured to heat the external air by using a heat source different from the compressed air; and
a control device configured to control the second heating unit such that the external air is heated by the heater in a high-load section where a gas turbine load is higher than a first specified load.

An operation method for an intake air heating system according to at least one embodiment of the present disclosure is an operation method for an intake air heating system configured to heat external air flowing through an intake flow path that communicates with a compressor of a gas turbine,
the intake air heating system including
a first heating unit including a return flow path for returning some of compressed air discharged from the compressor to the intake flow path, and
a second heating unit including a heater configured to heat the external air by using a heat source different from the compressed air, and
the operation method including: a second heating unit control step of controlling the second heating unit such that the external air is heated by the heater in a high-load section where a gas turbine load is higher than a first specified load.

The gas turbine system according to at least one embodiment of the present disclosure includes the intake air heating system and the gas turbine.

### Advantageous Effects of Invention

According to the present disclosure, it is possible to provide an intake air heating system, an operation method for an intake air heating system, and a gas turbine system that improve operation efficiency of a gas turbine.

### BRIEF DESCRIPTION OF DRAWINGS

FIG. 1 is a schematic view of a gas turbine system according to one embodiment.

FIG. 2 is a schematic graph showing a load section of a heating operation of a second heating unit according to one embodiment.

FIG. 3 is a schematic graph showing load sections of a heating operation of a first heating unit according to one embodiment.

FIG. 4 is a schematic view showing a second heating unit according to one embodiment.

FIG. 5 is a schematic graph showing a heating ratio of a first heating unit and a second heating unit according to one embodiment.

FIG. 6 is a schematic view showing details of a gas turbine according to one embodiment.

FIG. 7 is a flowchart showing an operation method for an intake air heating system according to one embodiment.

### DESCRIPTION OF EMBODIMENTS

Hereinafter, some embodiments of the present disclosure will be described with reference to the accompanying drawings. However, dimensions, materials, shapes, and relative dispositions of components described as the embodiments or illustrated in the drawings are not intended to limit the scope of the present disclosure, and are merely examples for describing the present disclosure.

For example, expressions representing relative or absolute dispositions such as “in a certain direction”, “along a certain direction”, “parallel”, “orthogonal”, “center”, “concentric”, or “coaxial” not only strictly represent the dispositions, but also represent a state of being relatively displaced with a tolerance or at an angle or a distance to the extent that the same function can be obtained.

For example, expressions representing that matters are in an equal state such as “same”, “equal”, and “homogeneous” not only represent a strictly equal state, but also represent a state where a tolerance or a difference exists to the extent that the same function can be obtained.

For example, expressions representing shapes such as a quadrangular shape and a cylindrical shape not only represent shapes such as a quadrangular shape and a cylindrical shape in a geometrically strict sense, but also represent shapes including an uneven portion, a chamfered portion, and the like within a range where the same effect can be obtained.

Meanwhile, expressions such as “being provided with”, “including”, or “having” one component are not exclusive expressions excluding existence of other components.

The same configurations are denoted by the same reference numerals, and the description thereof may be omitted.

### Overview of Gas Turbine System 1

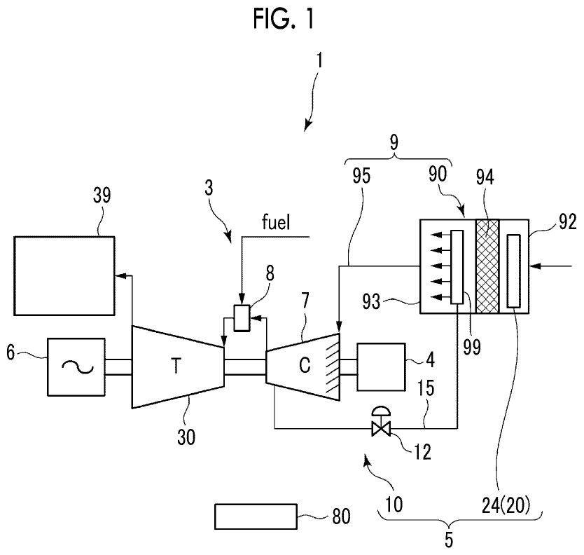

FIG. 1 is a schematic view of a gas turbine system 1 according to one embodiment of the present disclosure. A gas turbine 3 constituting the gas turbine system 1 includes a compressor 7, a combustor 8 that generates mixed fuel of compressed air generated by the compressor 7 and fuel, and a turbine 30 driven by combustion gas discharged from a combustor 8. The compressor 7 is configured to start rotation by means of a starting device 4. The fuel supplied to the combustor 8 is, for example, gas fuel, but may be liquid fuel. The turbine 30 of the present example is configured to drive a generator 6 by using combustion gas discharged from the combustor 8 as a power source. Exhaust gas discharged from the turbine 30 flows through an exhaust duct 39.

The compressor 7 communicates with an intake flow path 9. External air flowing through the intake flow path 9 is sent to the compressor 7 to generate compressed air. The gas turbine system 1 of the present disclosure includes an intake air heating system 5 configured to heat external air flowing through the intake flow path 9, and the intake air heating system 5 includes a first heating unit 10 and a second heating unit 20. The first heating unit 10 is configured to heat external air by using compressed air discharged from the compressor 7 as a heat source. More specifically, the first heating unit 10 includes a return flow path 15 for returning some of the compressed air discharged from the compressor 7 to the intake flow path 9. The external air is heated by mixing the compressed air returned from the return flow path 15 to the intake flow path 9 with the external air.

The intake flow path 9 shown in FIG. 1 includes an intake chamber 90 and an in take duct 95 that communicates with the intake chamber 90 and the compressor 7, and the return flow path 15 communicates with a discharge pipe 99 accommodated in the intake chamber 90. The compressed air flowing into the discharge pipe 99 from the return flow path 15 is discharged into the intake chamber 90 from a nozzle provided in the discharge pipe 99. The discharge pipe 99 of the present example is disposed between an intake filter 94 accommodated in the intake chamber 90 and an outlet 93 of the intake chamber 90.

The second heating unit 20 includes a heater 24 configured to heat the external air by using a heat source different from the compressor 7. A heat source of the heater 24 may be heat recovered from exhaust gas discharged from the turbine 30 (details will be described later) or may be heat obtained from a heat generating body that generates heat by means of the supply of electric power. The heater 24 shown in FIG. 1 is accommodated in the intake chamber 90, and, more specifically, is disposed between the intake filter 94 and an inlet 92 of the intake chamber 90. The heater 24 may be disposed between the intake filter 94 and the outlet 93.

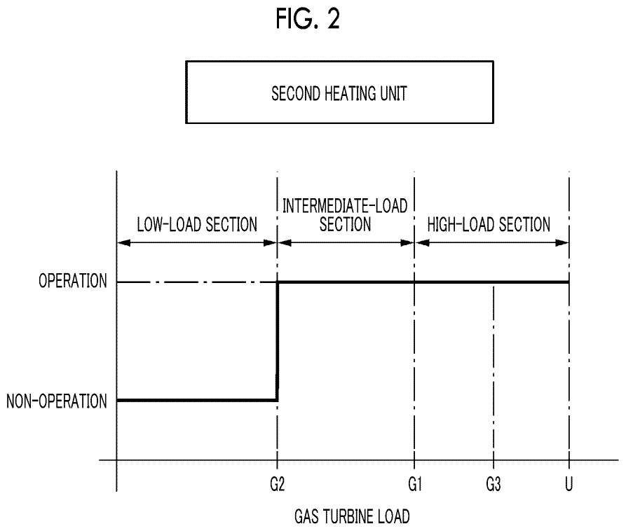

The heating control of the second heating unit 20 is executed by a control device 80, which is a component of the intake air heating system 5. The control device 80 controls the second heating unit 20 such that the external air is heated by the heater 24 in a high-load section where a gas turbine load is higher than a first specified load. The heating control of the second heating unit 20 by the control device 80 may be executed only in the high-load section. Alternatively, the second heating unit 20 may also execute the heating operation in sections other than the high-load section (see FIG. 2).

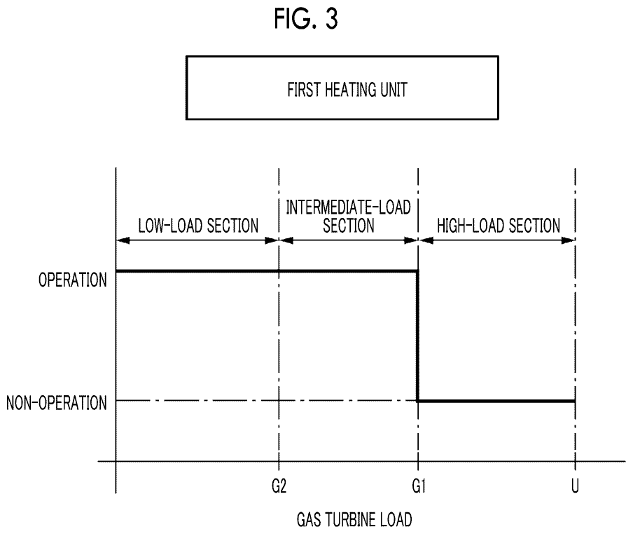

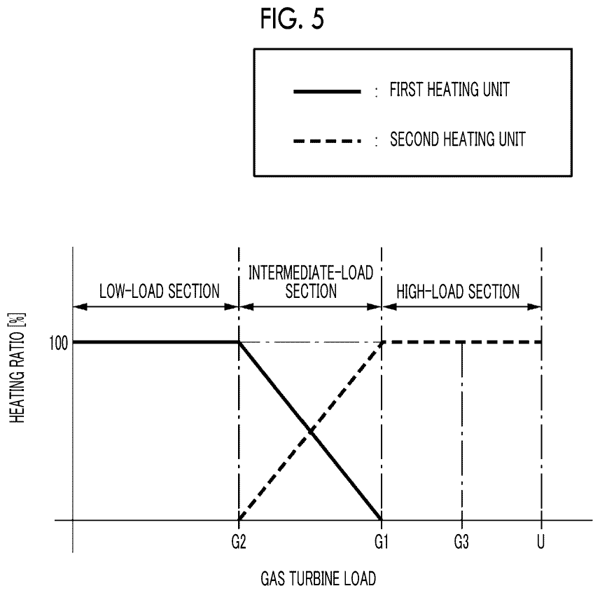

FIG. 2 is a schematic graph showing sections of a heating operation of the second heating unit 20 according to one embodiment. The horizontal axis in the graph indicates the gas turbine load, and G1 corresponds to the first specified load (the same applies to FIGS. 3 and 5). The first specified load is a load lower than a rated load of the gas turbine system 1, and is, for example, any gas turbine load of 75% or more and less than 95% with respect to the rated load. The heating amount in the operation section of the second heating unit 20 shown in FIG. 2 is not always constant. For example, the heating amount in the high-load section may be feedback-controlled according to the temperature of the exhaust gas discharged from the turbine 30, or the heating amount in the high-load section may be constant regardless of the temperature of the exhaust gas. In the present example, the feedback control is executed only in a case where the gas turbine load exceeds a high specified load (gas turbine load indicated by G3 in FIG. 3) that is higher than the first specified load, and the feedback control is not executed in a case where the gas turbine load is equal to or lower than the high specified load. The feedback control of the second heating unit 20 may be any of P control, PI control, or PID control, but PI control is adopted in the present example. Further, the operation of the gas turbine system 1 according to one embodiment may always be a partial load operation. In this case, the upper limit specified load (gas turbine load indicated by reference numeral U), which is the maximum gas turbine load in the high-load section, is lower than the rated load of the gas turbine system 1, and the operation in the load section where the load is higher than the upper limit specified load is not executed. The upper limit specified load is, for example, any gas turbine load of 80% or more and less than 100% with respect to the rated load. The upper limit specified load is a gas turbine load larger than the high specified load.

As shown in FIG. 2, the second heating unit 20 executes the heating operation not only in the high-load section but also in an intermediate-load section. The intermediate-load section is a section of the gas turbine load in which the gas turbine load is equal to or lower than the first specified load and equal to or higher than a second specified load, which is lower than the first specified load. G2 in FIG. 2 corresponds to the second specified load (the same applies to FIGS. 3 and 5). For example, in the intermediate-load section, the feedback control of the heating amount by the second heating unit 20 is not executed. As a more specific example, in the intermediate-load section, the opening degree of a second flow rate adjusting valve 22 (described later) of the second heating unit 20 is maintained constant. The second specified load is any gas turbine load of 30% or more and less than 60% with respect to the rated load of the gas turbine system 1.

According to the above-described configuration, the external air is heated by a heat source different from the compressed air in the high-load section. Accordingly, the flow rate of the compressed air flowing through the return flow path 15 as a heat source for heating the external air can be decreased, and the decrease in the flow rate of the combustion gas supplied to the turbine 30 can be suppressed in the high-load section. Therefore, the intake air heating system 5 in which operation efficiency of the gas turbine 3 is improved is realized.

### Details of First Heating Unit 10

Returning to FIG. 1, the first heating unit 10 further includes a first flow rate adjusting valve 12 disposed in the return flow path 15. The heating operation of the first heating unit 10 is controlled by the control device 80. More specifically, the control device 80 transmits a control signal to the first flow rate adjusting valve 12, so that the flow rate of the compressed air flowing through the return flow path 15 is controlled, and the heating amount of the first heating unit 10 with respect to the external air is controlled.

In one embodiment, the heating operation by the first heating unit 10 is executed in a low-load section where the gas turbine load is lower than the second specified load. That is, the control device 80 controls the first heating unit 10 such that the first flow rate adjusting valve 12 opens the return flow path 15 in the low-load section. The opening of the first flow rate adjusting valve 12 does not necessarily mean the full opening of the first flow rate adjusting valve 12. In a case where the opening degree of the first flow rate adjusting valve 12 exceeds 0%, it is understood that the first flow rate adjusting valve 12 is opened (the same applies to the second flow rate adjusting valve 22 described later). In addition, the heating control of the first heating unit 10 by the control device 80 may be executed only in the low-load section, or may be executed in sections other than the low-load section (see FIG. 3).

FIG. 3 is a schematic graph showing sections of a heating operation of the first heating unit 10 according to one embodiment. The horizontal axis in FIG. 3 indicates the gas turbine load. The heating amount in the operation section of the first heating unit 10 shown in FIG. 3 is not always constant. For example, the heating amount in the low-load section may be feedback-controlled according to the gas turbine load, or the heating amount in the low-load section may be constant regardless of the gas turbine load. In the present example, the heating amount of the first heating unit 10 is feedback-controlled in the low-load section. The feedback control of the first heating unit 10 may be any of P control, PI control, or PID control, but PI control is adopted in the present example.

As shown in FIG. 3, the first heating unit 10 executes the heating operation not only in the low-load section but also in the intermediate-load section. As a more specific example, in the intermediate-load section, the feedback control of the heating amount of the second heating unit 20 is executed. More specifically, in the intermediate-load section, the opening degree of the first flow rate adjusting valve 12 of the first heating unit 10 is feedback-controlled according to the exhaust temperature. In addition, in the example of FIG. 3. the heating operation by the second heating unit 20 is not executed in the high-load section. That is, the control device 80 controls the first heating unit 10 such that the first flow rate adjusting valve 12 closes the return flow path 15 in the high-load section.

According to the above configuration, when the first flow rate adjusting valve 12 is opened in the low-load section, the compressed air discharged from the compressor 7 is bled, and the external air is heated by the bled compressed air. As a result, the flow rate of the compressed air flowing into the combustor 8 is decreased, and the flow rate of the combustion gas for driving the turbine 30 is decreased. In this case, the fuel supplied to the combustor 8 is increased in order to maintain the output of the gas turbine system 1. As a result, since the combustion temperature in the combustor 8 is increased, the amount of carbon monoxide (CO) generated can be suppressed. As described above, the generation of CO can be suppressed in the low-load section, and operation efficiency of the gas turbine 3 can be improved in the high-load section. In above-addition, according to the described configuration, the first flow rate adjusting valve 12 closes the return flow path 15 in the high-load section. Accordingly, since the first heating unit 10 is not operated in the high-load section, operation efficiency of the gas turbine 3 can be further improved.

### Details of Second Heating Unit 20

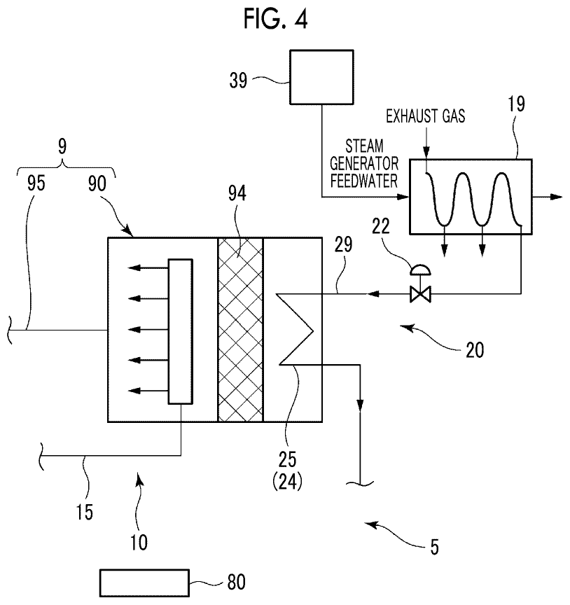

FIG. 4 is a schematic view showing the second heating unit 20 according to one embodiment of the present disclosure. A heat source of the second heating unit 20 shown in FIG. 4 is the exhaust gas discharged from the turbine 30 (see FIG. 1). The heat source of the exhaust gas is recovered by a heat recovery steam generator 19, which is a component of the gas turbine system 1, and is used as the heat source of the second heating unit 20. The heat recovery steam generator 19 is configured to generate a heating medium from steam generator feedwater by using exhaust gas supplied from an exhaust duct 39 as a heat source. The heating medium is hot water or steam (superheated steam). For example, superheated steam is generated by heating the steam generator feedwater with the high-temperature exhaust gas that has relatively recently flowed into the heat recovery steam m generator 19. This superheated steam may be supplied to other devices constituting the gas turbine system 1, such as a steam turbine. Meanwhile, the low-temperature exhaust gas flowing in the vicinity of the outlet in the heat recovery steam generator 19 heats the steam generator feedwater, so that hot water is generated (this hot water may further flow in the heat recovery steam generator 19 and may be changed into the superheated steam by heat exchange with the high-temperature exhaust gas).

The description of the second heating unit 20 will be continued. The second heating unit 20 according to one embodiment includes a heating medium flow path 29 for guiding the heating medium generated by the heat recovery steam generator 19 to the intake chamber 90 of the intake flow path 9, the second flow rate adjusting valve 22 provided in the heating medium flow path 29, and a pipe portion 25 which is the heater 24 disposed in the intake flow path 9. As described above, the second heating unit 20 is controlled by the control device 80. In the present example, when the second flow rate adjusting valve 22 is opened in response to the control signal transmitted from the control device 80 to the second flow rate adjusting valve 22, the heating medium is supplied from the heat recovery steam generator 19 to the pipe portion 25 via the heating medium flow path 29. In addition, the flow rate of the heating medium flowing through the pipe portion 25 is controlled by controlling the opening degree of the second flow rate adjusting valve 22. As a result, the heating amount of the second heating unit 20 with respect to the external air is controlled. When the graph in FIG. 2 is taken as an example, as the gas turbine load is increased in the intermediate-load section, the opening degree of the second flow rate adjusting valve 22 is increased and the opening degree of the second flow rate adjusting valve 22 is substantially constant in the high-load section. The heating medium flowing through the heating medium flow path 29 shown in FIG. 4 is hot water, and the hot water has a higher temperature than the steam generator feedwater before flowing into the heat recovery steam generator 19.

The control device 80 according to one embodiment controls the second heating unit 20 such that the second flow rate adjusting valve 22 closes the heating medium flow path 29 in the low-load section. Therefore, the second heating unit 20 does not execute the heating operation with the low-respect to external air in the load section. According to the above configuration, in the low-load section, the flow rate of the compressed air flowing through the return flow path 15 can be increased by the amount of the external air that is not heated by the second heating unit 20. Therefore, the generation of CO can be further suppressed in the low-load section.

### Example of Heating Control of First Heating Unit 10 and Second Heating Unit 20

FIG. 5 is a schematic graph showing a heating ratio of the first heating unit 10 and the second heating unit 20 according to one embodiment. The horizontal axis in FIG. 5 indicates the gas turbine load, and the vertical axis indicates the ratio of the heating amount of the first heating unit 10 to the heating amount of the second heating unit 20. For example, the first heating unit 10 performs all the heating of the external air in the low-load section, and the second heating unit 20 performs all the heating in the high-load section. The vertical axis in FIG. 5 merely indicates the ratio of the heating amount of the first heating unit 10 to the heating amount of the second heating unit 20. Therefore, the heating amount with respect to the external air is not always constant over the low-load section, the intermediate-load section, and the high-load section.

In the intermediate-load section shown in FIG. 5, both the first heating unit 10 and the second heating unit 20 perform heating. As a more specific example, the control device 80 controls the first heating unit 10 and the second heating unit 20 such that the first flow rate adjusting valve 12 opens the return flow path 15 and the second flow rate adjusting valve 22 opens the heating medium flow path 29. In the intermediate-load section shown in FIG. 5, as the gas turbine load is increased, the heating ratio of the first heating unit 10 is decreased and the heating ratio of the second heating unit 20 is increased. The reason is as follows.

In the feedback control of the first flow rate adjusting valve 12 in the intermediate-load section, the opening degree of the first flow rate adjusting valve 12 is controlled based on, for example, a target value of the exhaust temperature and on an actual measured value thereof from the turbine 30. In this case, the amount of fuel supplied to the combustor 8 in order to increase the gas turbine load is relatively high, and the exhaust temperature is increased as the gas turbine load is increased. As a result, the feedback control of decreasing the opening degree of the first flow rate adjusting valve 12 is executed, and the heating amount of the first heating unit 10 is decreased. Meanwhile, in the intermediate-load section, the control is executed such that the heating amount of the second heating unit 20 is increased as the gas turbine load is increased. As a more specific example, the opening degree of the second flow rate adjusting valve 22 is increased as the gas turbine load is increased. Therefore, as the gas turbine load in the intermediate-load section is increased, the heating ratio of the first heating unit 10 is decreased and the heating ratio of the second heating unit 20 is increased.

According to the above configuration, the first heating unit 10 and the second heating unit 20 perform the heating operation of the external air in the intermediate-load section. As a result, it is possible to operate the gas turbine system 1 in which a balance in both the suppression of the generation of CO and operation efficiency of the gas turbine 3 is maintained.

### Details of Gas Turbine 3

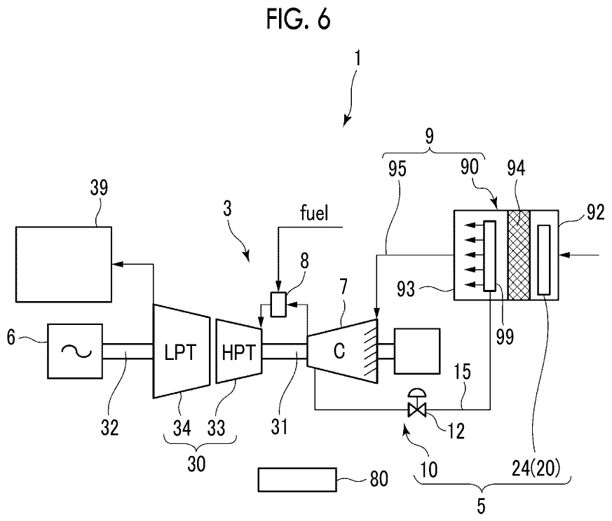

FIG. 6 is a schematic view showing details of the gas turbine 3 according to one embodiment of the present disclosure. The gas turbine 3 in FIG. 6 is a two-shaft gas turbine. More specifically, the gas turbine 3 includes the compressor 7, a high-pressure turbine 33 having a first shaft 31 connected to a rotating shaft of the compress or 7, and a low-pressure turbine 34 having a second shaft 32 different from the first shaft 31. The high-pressure turbine 33 rotates integrally with the compressor 7. In addition, the low-pressure turbine 34 is configured to receive exhaust gas supplied from the high-pressure turbine 33, and is configured to rotate by using the exhaust gas as a power source. Exhaust gas discharged from the low-pressure turbine 34 flows to the exhaust duct 39.

An inlet guide vane is provided at an inlet of the compressor 7, and the intake amount of the compressor 7 is controlled by adjusting the opening degree of the inlet guide vane. In the two-shaft gas turbine, the opening degree control of the inlet guide vane of the compressor 7 is executed in order to maintain a balance between the output of the high-pressure turbine 33 and the power of the compressor 7. Therefore, for example, in a case where the turbine inlet temperature is decreased according to a decrease in the amount of fuel supplied to the combustor 8 of the gas turbine 3, it is difficult to execute the control of narrowing the opening degree of the inlet guide vane such that the turbine inlet temperature is increased. In this regard, according to the above configuration, the second heating unit 20 heats the external air using a heat source different from the compressed air in the high-load section, thereby increasing the turbine inlet temperature. Since the use of the compressed air discharged from the compressor 7 as a heat source is suppressed, it is also possible to suppress a decrease in a flow rate of the combustion gas flowing into the turbine 30. As described above, operation efficiency in the two-shaft gas turbine can be improved.

### Operation Method for Intake Air Heating System 5

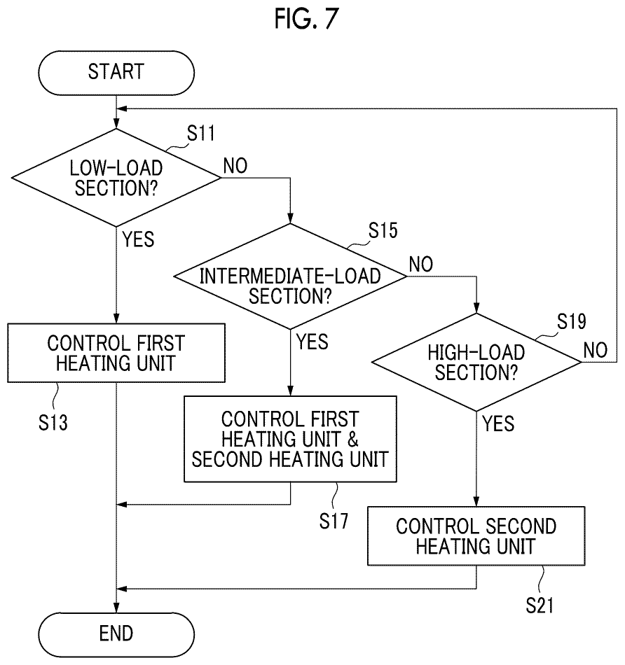

FIG. 7 is a flowchart showing an operation method for the intake air heating system 5 according to one embodiment of the present disclosure. The method is executed by the control device 80 as an example. For example, the control device 80 is configured with a computer and includes a processor, a memory, and an external communication interface. The processor is a CPU, a GPU, an MPU, a DSP, a combination thereof, or the like. The processor according to other embodiments may be realized by an integrated circuit such as a PLD, an ASIC, an FPGA, or an MCU. The memory is configured to temporarily or non-temporarily store various types of data, and is realized by, for example, at least one of a RAM, a ROM, or a flash memory. In accordance with an instruction of a program loaded in the memory, the processor of the control device 80 (hereinafter, may be simply referred to as a “processor”) executes control processing for operating the intake air heating system 5. During the execution of the control processing, the processor transmits a control signal to the first flow rate adjusting valve 12 and the second flow rate adjusting valve 22. In the following description, steps may be abbreviated as “S”.

First, it is determined whether or not the gas turbine load is included in the low-load section (S11). For example, the processor acquires a command indicating a specific gas turbine load, and thus it is determined whether or not the gas turbine load is included in the low-load section. In a case where it is determined that the gas turbine load is included in the low-load section (S11: YES), a first heating unit control step of controlling the first heating unit 10 is executed (S13). The controlling method for the first heating unit 10 in the low-load section is as described above, and the processor transmits a predetermined control signal to the first flow rate adjusting valve 12. In addition, in this case, the processor transmits a control signal for the second flow rate adjusting valve 22 to close the heating medium flow path 29. After the execution of S13, the operation method for the intake air heating system 5 ends.

In a case where it is determined that the gas turbine load is not included in the low-load section (S11: NO), it is determined whether or not the gas turbine load is included in the intermediate-load section (S15). The determination method in S15 is the same as the determination method in S11. In a case where it is determined that the gas turbine load is included in the intermediate-load section (S15: YES), a control step of controlling the first heating unit 10 and the second heating unit 20 is executed (S17). The controlling method for the first heating unit 10 and the second heating unit 20 in the intermediate-load section is as described above, and the processor transmits a predetermined signal to each of the first flow rate adjusting valve 12 and the second flow rate adjusting valve 22. After the execution of S17, the operation method for the intake air heating system 5 ends.

In a case where it is determined that the gas turbine load is not included in the intermediate-load section (S15: NO), it is determined whether or not the gas turbine load is included in the high-load section (S19). The determination method in S19 is the same as the determination method in S11. In a case where it is determined that the gas turbine load is included in the high-load section (S19: YES), the second heating unit control step of controlling the second heating unit 20 is executed (S21). The controlling method for the second heating unit 20 in the high-load section is as described above. In addition, in this case, the processor transmits a control signal for the first flow rate adjusting valve 12 to close the return flow path 15.

After the execution of S21, the operation method for the intake air heating system 5 ends. In a case where it is determined that the gas turbine load is not included in the high-load section (S19: NO), the step returns to S11.

### SUMMARY

The contents described in some of the above-described embodiments are understood as follows, for example.
1) An intake air heating system (5) according to at least one embodiment of the present disclosure is the intake air heating system (5) configured to heat external air flowing through an intake flow path (9) that communicates with a compressor (7) of a gas turbine (3), the intake air heating system (5) including:
a first heating unit (10) including a return flow path (15) for returning some of compressed air discharged from the compressor (7) to the intake flow path (9);
a second heating unit (20) including a heater (24) configured to heat the extern al air by using a heat source different from the compressed air; and
a control device (80) configured to control the second heating unit (20) such that the external air is heated by the heater (24) in a high-load section where a gas turbine load is higher than a first specified load.

According to the configuration of the above 1), the external air is heated by a heat source different from the compressed air in the high-load section. Accordingly, the flow rate of the compressed air flowing through the return flow path (15) as a heat source for heating the external air can be decreased, and the decrease in the flow rate of the combustion gas supplied to the turbine (30) can be suppressed in the high-load section. Therefore, the intake air heating system (5) in which operation efficiency of the gas turbine (3) is improved is realized.
2) In some embodiments, the intake air heating system (5) is the intake air heating system (5) according to 1), in which
the first heating unit (10) further includes a first flow rate adjusting valve (12) that is disposed in the return flow path (15), and
the control device (80) is configured to control the first heating unit (10) such that the first flow rate adjusting valve (12) opens the return flow path (15) in a low-load section where the gas turbine load is lower than a second specified load that is lower than the first specified load.

According to the configuration of the above 2), when the first flow rate adjusting valve (12) is opened in the low-load section, the compressed air discharged from the compressor (7) is bled, and the external air is heated by the bled compressed air. As a result, the flow rate of the compressed air flowing into the combustor (8) is decreased, and the flow rate of the combustion gas driving the turbine (30) is decreased. In this case, the fuel supplied to the combustor (8) is increased in order to maintain the output of the gas turbine system (1). As a result, since the combustion temperature in the combustor (8) is increased, the amount of carbon monoxide (CO) generated can be suppressed. As described above, the generation of co can be suppressed in the low-load section, and operation efficiency of the gas turbine (3) can be improved in the high-load section.
3) In some embodiments, the intake air heating system (5) is the intake air heating system (5) according to 2), in which
the control device (80) is configured to control the first heating unit (10) such that the first flow rate adjusting valve (12) closes the return flow path (15) in the high-load section.

According to the configuration of the above 3), since the first heating unit (10) is not operated in the high-load section, operation efficiency of the gas turbine (3) can be further improved.
4) In some embodiments, the intake air heating system (5) is the intake air heating system (5) according to 3), in which
the second heating unit (20) includes
a heating medium flow path (29) for guiding a heating medium, which is generated by heating steam generator feedwater with a heat recovery steam generator (19) to which exhaust gas from the gas turbine is supplied (3), to the intake flow path (9),
a second flow rate adjusting valve (22) provided in the heating medium flow path (29), and
a pipe portion (25) that is disposed in the intake flow path (9) and that is the heater (24) configured such that the heating medium is supplied from the heating medium flow path (29), and
the control device (80) is configured to control the second heating unit (20) such that the second flow rate adjusting valve (22) closes the heating medium flow path (29) in the low-load section.

According to the configuration of the above 4), in the low-load section, the flow rate of the compressed air flowing through the return flow path (15) can be increased by the amount of the external air that is not heated by the second heating unit (20). Therefore, the generation of CO can be further suppressed in the low-load section.
5) In some embodiments, the intake air heating system (5) is the intake air heating system (5) according to 4), in which
the control device (80) is configured to control the first heating unit (10) and the second heating unit (20) such that the first flow rate adjusting valve (12) opens the return flow path (15) and the second flow rate adjusting valve (22) opens the heating medium flow path (29) in an intermediate-load section where the gas turbine load is equal to or higher than the second specified load and equal to or lower than the first specified load.

According to the configuration of the above 5), the first heating unit (10) and the second heating unit (20) perform the heating operation of the external air in the intermediate-load section. As a result, it is possible to operate the gas turbine system (1) in which a balance in both the suppression of the generation of CO and operation efficiency of the gas turbine (3) is maintained.
6) An operation method for the intake air heating system (5) according to at least one embodiment of the present disclosure is the operation method for the intake air heating system (5) configured to heat external air flowing through the intake flow path (9) that communicates with the compressor (7) of the gas turbine (3).
the intake air heating system (5) including
the first heating unit (10) including the return flow path (15) for returning some of compressed air discharged from the compressor (7) to the intake flow path (9), and
the second heating unit (20) including the heater (24) configured to heat the external air by using a heat source different from the compressed air, and
the operation method including: a second heating unit control step (S21) of controlling the second heating unit (20) such that the external air is heated by the heater (24) in a high-load section where a gas turbine load is higher than a first specified load.

According to the configuration of the above 6), the operation method for the in take air heating system (5) in which operation efficiency of the gas turbine (3) is improved is realized for the same reason as in the above 1).
7) The gas turbine system (1) according to at least one embodiment of the present disclosure includes:
the intake air heating system (5) according to any one of 1) to 5); and
the gas turbine (3).

According to the configuration of the above 7), the gas turbine system (1) in which operation efficiency of the gas turbine (3) is improved is realized for the same reason as in the above 1).
8) In some embodiments, the gas turbine system (1) is the gas turbine system (1) according to 7), in which
the gas turbine (3) is a two-shaft gas turbine including
the compressor (7),
a high-pressure turbine (33) having a first shaft (31) connected to a rotating shaft of the compressor (7), and
a low-pressure turbine (34) having a second shaft (32) different from the first shaft (31) and configured such that exhaust gas is supplied from the high-pressure turbine (33).

In the two-shaft gas turbine, the opening degree control of the inlet guide vane of the compressor (7) is executed in order to maintain a balance between the output of the high-pressure turbine (33) and the power of the compressor (7). Therefore, for example, in a case where the turbine inlet temperature is decreased according to a decrease in the amount of fuel supplied to the combustor (8) of the gas turbine (3), it is difficult to execute the control of narrowing the opening degree of the inlet guide vane such that the turbine inlet temperature is increased. In this regard, according to the configuration of the above 8), the second heating unit (20) heats the external air using a heat source different from the compressed air, thereby increasing the turbine inlet temperature. Since the use of the compressed air discharged from the compressor (7) as a heat source is suppressed, it is also possible to suppress a decrease in a flow rate of the combustion gas flowing into the turbine (30). As described above, operation efficiency in the two-shaft gas turbine can be improved.

### REFERENCE SIGNS LIST

1: gas turbine system
3: gas turbine
5: intake air heating system
7: compressor
9: intake flow path
10: first heating unit
12: first flow rate adjusting valve
15: return flow path
19: heat recovery steam generator
20: second heating unit
22: second flow rate adjusting valve
24: heater
25: pipe portion
29: heating medium flow path
30: turbine
31: first shaft
32: second shaft
33: high-pressure turbine
34: low-pressure turbine
80: control device

1. An intake air heating system configured to heat external air flowing through an intake flow path that communicates with a compressor of a gas turbine, the intake air heating system comprising:
a first heating unit including a return flow path for returning some of compressed air discharged from the compressor to the intake flow path;
a second heating unit including a heater configured to heat the external air by using a heat source different from the compressed air; and
a control device configured to control the second heating unit such that the external air is heated by the heater in a high-load section where a gas turbine load is higher than a first specified load.

2. The intake air heating system according to claim 1, wherein
the first heating unit further includes a first flow rate adjusting valve that is disposed in the return flow path, and
the control device is configured to control the first heating unit such that the first flow rate adjusting valve opens the return flow path in a low-load section where the gas turbine load is lower than a second specified load that is lower than the first specified load.

3. The intake air heating system according to claim 2, wherein
the control device is configured to control the first heating unit such that the first flow rate adjusting valve closes the return flow path in the high-load section.

4. The intake air heating system according to claim 2, wherein
the second heating unit includes
a heating medium flow path for guiding a heating medium, which is generated by heating steam generator feedwater with a heat recovery steam generator to which exhaust gas from the gas turbine is supplied, to the intake flow path,
a second flow rate adjusting valve provided in the heating medium flow path, and
a pipe portion that is disposed in the intake flow path and that is the heater configured such that the heating medium is supplied from the heating medium flow path, and
the control device is configured to control the second heating unit such that the second flow rate adjusting valve closes the heating medium flow path in the low-load section.

5. The intake air heating system according to claim 4, wherein
the control device is configured to control the first heating unit and the second heating unit such that the first flow rate adjusting valve opens the return flow path and the second flow rate adjusting valve opens the heating medium flow path in an intermediate-load section where the gas turbine load is equal to or higher than the second specified load and equal to or lower than the first specified load.

6. An operation method for an intake air heating system configured to heat external air flowing through an intake flow path that communicates with a compressor of a gas turbine,
the intake air heating system including
a first heating unit including a return flow path for returning some of compressed air discharged from the compressor to the intake flow path, and
a second heating unit including a heater configured to heat the external air by using a heat source different from the compressed air, and
the operation method comprising: a second heating unit control step of controlling the second heating unit such that the external air is heated by the heater in a high-load section where a gas turbine load is higher than a first specified load.

7. A gas turbine system comprising:
the intake air heating system according to claim 1; and
the gas turbine.

8. The gas turbine system according to claim 7, wherein
the gas turbine is a two-shaft gas turbine including
the compressor,
a high-pressure turbine having a first shaft connected to a rotating shaft of the compressor, and
a low-pressure turbine having a second shaft different from the first shaft and configured such that exhaust gas is supplied from the high-pressure turbine.
